(19) United States
(12) Patent Application Publication
(10) Pub. No.: US 2025/0280320 A1
(43) Pub. Date: Sep. 4, 2025

(54) SYSTEMS AND METHODS FOR QUALITY OF SERVICE HANDLING FOR EXTENDED REALITY TRAFFIC

(71) Applicant: ZTE CORPORATION, Shenzhen, Guangdong (CN)

(72) Inventors: Jinguo ZHU, Shenzhen, Guangdong (CN); Guanghui LU, Shenzhen, Guangdong (CN); Jianfeng ZHOU, Shenzhen, Guangdong (CN); Weibin WANG, Shenzhen, Guangdong (CN)

(21) Appl. No.: 18/863,630

(22) PCT Filed: Nov. 28, 2022
(86) PCT No.: PCT/CN2022/134551

§ 371 Date: Nov. 6, 2024

(51) Int. Cl. H04W 28/02; H04L 47/24; H04L 47/32; H04L 67/131

(52) U.S. Cl. CPC H04W 28/0268; H04L 47/24; H04L 47/32; H04L 67/131

(57) ABSTRACT

Presented are systems and methods for quality of service (QOS) handling for extended reality (XR) traffic. A first network entity can determine that a service data flow is transferred via a first Quality of Service (QOS) flow and a second QoS flow. The first network entity can send a first message indicating that at least one packet of the second QoS flow can be dropped when the wireless communication node determines that a sum of a first bit rate of the first Qos flow and a second bit rate of the second QoS flow is greater than a threshold associated with the first QoS flow to a wireless communication node.

### TECHNICAL FIELD

The disclosure relates generally to wireless communications, including but not limited to systems and methods for quality of service (QOS) handling for extended reality (XR) traffic.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A first network entity (e.g. a session management function (SMF)) can determine that a service data flow is transferred via a first Quality of Service (QOS) flow and a second QoS flow. The first network entity can send a first message indicating that at least one packet of the second QoS flow can be dropped when the wireless communication node determines that a sum of a first bit rate of the first QoS flow and a second bit rate of the second QoS flow is greater than a threshold associated with the first QoS flow to a wireless communication node (e.g., a radio access network (RAN)). The threshold can be a Maximum Flow Bit Rate (MFBR) of the first QoS flow.

In some embodiments, the first network entity may determine that a second priority value of the second QoS flow is less than a first priority value of the first QoS flow. The first network entity may send a second message indicating that the first QoS flow is a primary QoS flow and the second QoS flow is a secondary QoS flow to the wireless communication node.

In some embodiments, the first network entity may send a third message indicating that a second priority value of data packets included in the second QoS flow is less than a first priority value of data packets included in the first QoS flow to the wireless communication node.

In some embodiments, the first network entity may determine that a resource type of the second QoS flow is non-Guaranteed Bit Rate (non-GBR). The first network entity may include a QoS Flow identifier (QFI) of the first QoS flow in a QoS profile of the second QoS flow.

In some embodiments, the first network entity may send a fourth message that indicates the second network entity to forward a downlink service data flow into the first QoS flow and second QoS flow according to a traffic detection rule to a second network entity (e.g., a policy control function (PCF)).

In some embodiments, the first network entity may send a fifth message indicates that the first QoS flow and second QoS flow are associated with each other to a wireless communication device (e.g., a UE).

In some embodiments, a wireless communication node (e.g., a radio access network (RAN)) may receive a first message indicating a Quality of Service (QOS) profile of a first QoS flow and a second QoS flow from a first network entity (e.g., a session management function (SMF)). The wireless communication node may drop at least one packet of the second QoS flow when the wireless communication node determines that a sum of a first bit rate of the first QoS flow and a second bit rate of the second QoS flow is greater than a threshold associated with the first QoS flow. The first message includes information indicating that the at least one packet of the second QoS flow can be dropped when the wireless communication node determines that the sum of the first bit rate of the first QoS flow and a second bit rate of the second QoS flow is greater than the threshold associated with the first QoS flow.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example architecture of a 5G system, in accordance with some embodiments of the present disclosure;

FIG. 4 illustrates an example resource for quality of service (QOS) handling, in accordance with some embodiments of the present disclosure;

FIG. 5 illustrates a sequence diagram illustrating extended reality (XR) traffic, in accordance with some embodiments of the present disclosure;

FIG. 6 illustrates a sequence diagram illustrating extended reality (XR) traffic, in accordance with some embodiments of the present disclosure; and

FIG. 7 illustrates a flow diagram for quality of service (QOS) handling for extended reality (XR) traffic, in accordance with an embodiment of the present disclosure.

### DETAILED DESCRIPTION

### A. 1. Mobile Communication Technology and Environment

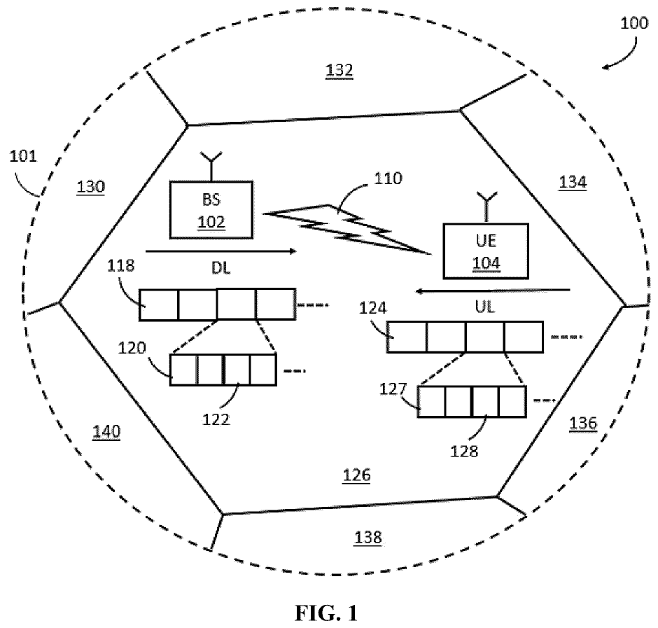

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

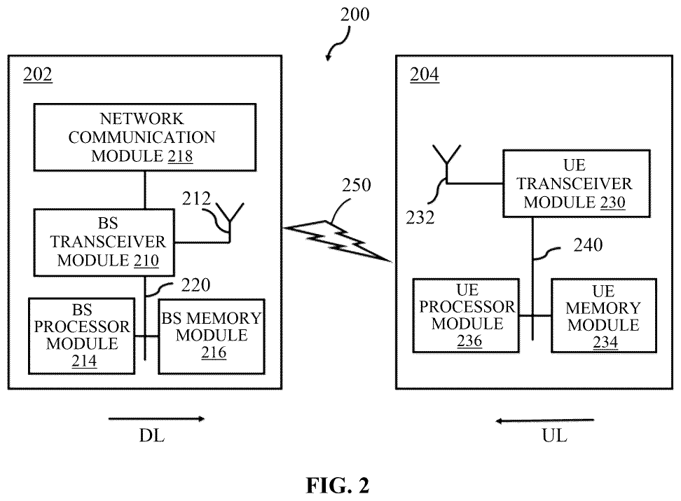

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### B. 2. Systems and Methods for Quality of Service (QOS) Handling for Extended Reality (XR) Traffic

Mobile media services, cloud augmented reality (AR)/virtual reality (VR), cloud gaming, video-based tele-control for machines or drones, can be expected to contribute more and more traffics to a 5G network. All media traffics may have some common characteristics. These characteristics can be very useful for better transmission control and efficiency. However, current 5G system uses common quality of service (QOS) mechanisms to deliver media services per packet without taking media information into account, which may not be an efficient way to deliver the media services.

Packets within a frame may have dependency with each other since an application may rely on all of these packets for decoding the frame. Hence, one packet loss may make other correlative packets useless even they are successfully transmitted. For example, XR applications may impose requirements in terms of media units (e.g., application data units), rather than in terms of single packets/packet data units (PDUs).

Packets of same video stream but different frame types (e.g., I/P frame) or even different positions in group of picture (GoP) can be of different contributions to user experience. Therefore, the QoS mechanism may be enhanced to handle this new type of traffic. This disclosure provides a solution to enhance an existing QoS mechanism so a radio access network (RAN) can deliver extended reality (XR) media service more efficiently.

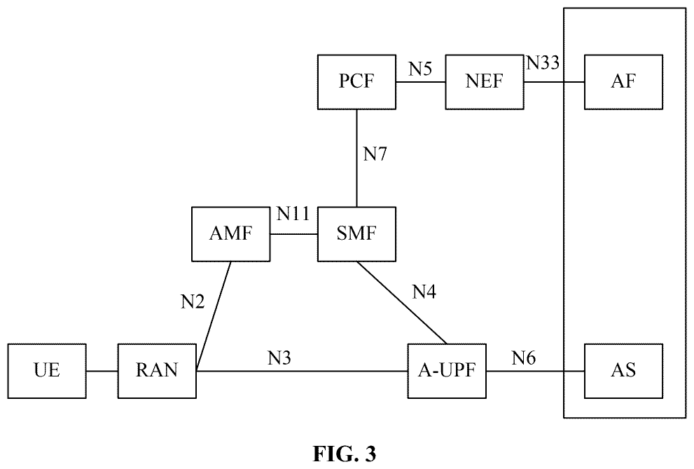

FIG. 3 illustrates an example architecture of a 5G system, in accordance with some embodiments of the present disclosure. The architecture may include at least one of following functions: a user equipment (UE), a radio access network (RAN), an access and mobility management function (AMF), a session management function (SMF), a user plane function (UPF), a policy control function (PCF), a network exposure function (NEF), and an application function (AF).

The user equipment (UE) can be any device used directly by an end-user to communicate.

The radio access network (RAN) may manage a radio resource. The RAN may deliver user data received over a N3 interface to the UE and may deliver the user data from the UE over N3 interface. The RAN may perform mapping between dedicated radio bearers (DRBs) and QoS flows in a packet data unit (PDU) session.

The access and mobility management function (AMF) may include at least one of following functionalities: registration management, connection management, reachability management and mobility management. This function may perform an access authentication and access authorization. The AMF can be a non-access stratum (NAS) security termination and may relay a session management (SM) NAS between a UE and a SMF.

The session management function (SMF) may include at least one of following functionalities: session establishment, modification and release, UE IP address allocation & management (e.g., optional authorization functions), selection and control of UP function, and downlink data notification. The SMF may control a user plane function (UPF) via N4 association. The SMF may provide at least one of: a packet detection rule (PDR) to the UPF to instruct how to detect user data traffic, a forwarding action rule (FAR), a QoS enforcement rule (QER), a usage reporting rule (URR) to instruct the UPF how to perform the user data traffic forwarding, and a QoS handling and usage reporting for the user data traffic detected by using the PDR.

The user plane function (UPF) may include at least one of following functionalities: serving as an anchor point for intra-/inter-radio access technology (RAT) mobility, packet routing & forwarding, traffic usage reporting, QoS handling for the user plane, and downlink packet buffering and downlink data notification triggering. A GPRS tunneling protocol user plane (GTP-U) tunnel can be used over a N3 interface between the RAN and the UPF. The GTP-U tunnel can be per PDU session. For downlink traffic, the UPF may bind the downlink traffic to QoS flows within the GTP-U tunnel of the PDU session by using the forwarding action rules (FARs) received from the SMF. For uplink traffic, the RAN may transfer the user plane traffic to QoS flows identified by the UE.

The policy control function (PCF) may provide QoS policy rules to control plane functions to enforce the rules. The PCF(s) may transform application function (AF) requests into policy and charging control (PCC) rules that may apply to PDU sessions.

The network exposure function (NEF) may provide a security mechanism to a third party AF to access the network. The NEF may authenticate and may authorize the application functions.

The application function (AF) may interact with the core network in order to provide services. Based on an operator deployment, application functions considered to be trusted by the operator can be allowed to interact directly with relevant network functions. Application functions not allowed by the operator to access directly the network functions may use the external exposure framework via the NEF to interact with relevant network functions.

In 5G, the data traffic can be encapsulated and can be transmitted in a QoS flow. The QoS Flow can be a finest granularity for QoS forwarding treatment in the 5G System. All traffic mapped to the same 5G QoS flow may receive the same forwarding treatment (e.g., scheduling policy, queue management policy, rate shaping policy, or radio link control (RLC) configuration). Different QoS forwarding treatment may require a separate 5G QoS flow.

A QOS flow may either be “guaranteed bit rate (GBR)” or “Non-GBR” depending on its QoS profile. The QoS profile of a QoS flow can be sent to the RAN. The QoS may contain QoS parameters. The QoS parameters may include a 5G QoS identifier (5QI) and allocation and retention priority (ARP), and other parameters such as a guaranteed flow bit rate (GFBR), and a maximum flow bit rate (MFBR). The 5QI can be a scalar that is used as a reference to a specific QoS forwarding behavior (e.g., packet loss rate, packet delay budget). The 5QI can identify a set of QoS characteristics (e.g., resource type, Non-GBR, GBR, delay-critical GBR), a priority level, a packet delay budget, a packet error rate, and an averaging window. The 5QI can be pre-configured 5QI or standardized 5QI.

Each QoS profile may have one corresponding QoS flow identifier (QFI). User plane traffic with the same QFI within a PDU session may receive the same traffic forwarding treatment (e.g., scheduling, admission threshold). The QFI can be carried in an encapsulation header on N3 (and N9). For example, the QFI may be carried in the encapsulation header without any changes to the end-to-end (e2e) packet header. The QFI can be unique within a PDU session. The QFI may be dynamically assigned or may be equal to the 5QI.

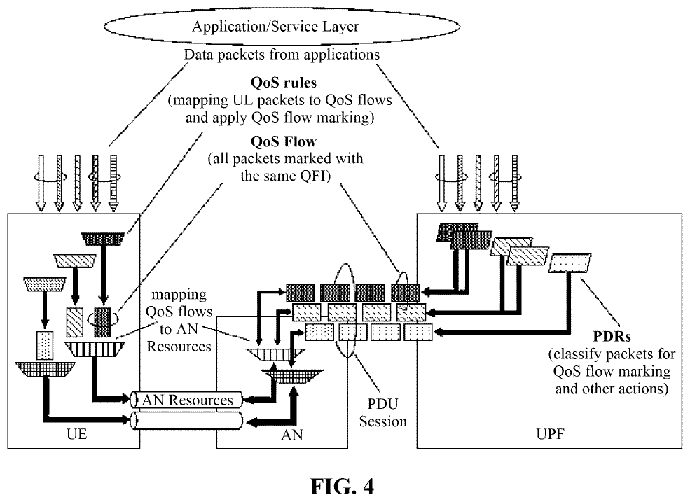

The principle for classification and marking of user plane traffic, and mapping of Qos flows to access network (AN) resources is shown in FIG. 4.

In a downlink (DL), incoming data packets can be classified by the UPF based on the packet filter sets of the DL packet detection rules (PDRs) in the order of their precedence. The UPF may convey the classification of the user plane traffic belonging to a QoS flow through an N3 (and N9) user plane marking using a QFI. The AN may bind QoS flows to AN resources (e.g., data radio bearers of the RAN). There can be no strict one to one relation between QoS flows and AN resources. The AN may establish the AN resources that QoS flows can be mapped to, and/or to release them.

In an uplink (UL), the UE may evaluate UL packets against the UL packet filters in the packet filter set in the QoS rules based on the precedence value of QoS rules in increasing order until a matching QoS rule (e.g., whose Packet Filter matches the UL packet) is found. The UE may use the QFI in the corresponding matching QoS rule to bind the UL packet to a QoS flow. The UE may bind QoS flows to AN resources.

For XR/media services, a group of packets can be used to carry payloads of a PDU set (e.g., a frame, video slice/tile). A PDU set can include one or more PDUs carrying the payload of one unit of information generated at the application level. In a media layer, packets in such a PDU set can be decoded/handled as a whole. For example, the frame/video slice may be decoded in case all or certain amount of the packets carrying the frame/video slice are successfully delivered. On the other hand, different PDU sets may have different importance. For example, an I frame can be more important than a P frame or a B frame. If the RAN is congested, the RAN can drop the P frame or the B frame, but the RAN may ensure the I frame to be transferred successfully. This disclosure provides a solution to enhance the existing QoS mechanism so that the RAN can deliver XR media services more efficiently.

This disclosure proposes at least one of following mechanisms. For downlink XR traffic, the UPF may classify incoming data packets based on importance and may convey the important PDU set into QoS flow 1 and non-important PDU set into separated QoS flow 2. A RAN may determine that a sum of a first bit rate of a first Quality-of-Service (QOS) flow and a second bit rate of a second QoS flow is greater than a threshold associated with the first QoS flow (e.g. maximum flow bit rate (MFBR)). The SMF may determine the first QoS flow and the second QoS flow for the service data flow. The SMF may send information to the RAN indicating that these two QoS flows can be associated with each other and the data packets in QoS flow 2 can be dropped if the sum of bit rate of both QoS flow 1 and QoS flow 2 exceeds the threshold associated with the QoS flow 1 (e.g. maximum flow bit rate (MFBR)).

The SMF may determine a QoS profile of a QoS flow 1 according to an existing Qos mechanism (e.g., PCC rule received from the PCF).

The SMF may determine a QoS profile of a QoS flow 2 as follows.

(i) The QoS profiles of the QoS flow 2 can be set same as QoS profile of the QoS flow 1, except setting the priority of QoS flow 2 to a lower priority value. This may ensure that data packets in the QoS flow 1 has a higher priority than data packets in the QoS flow 2.

(ii) The SMF may send information to the RAN to indicate that the QoS flow 1 can be the primary QoS flow, and the QoS flow 2 can be the secondary QoS flow. Data packets in the secondary QoS flow may have a less priority than the data packets in the primary QoS flow.

(iii) The SMF may send information to the RAN information to indicate that the data packets in the QoS flow 2 can be dropped if the sum of bit rate of both QoS flow 1 and QoS flow 2 exceeds the MFBR of QoS flow 1, even if the bit rate of QOS flow 2 is still under the GFBR of QoS flow. On guaranteed bit rate, the RAN may enforce the separated GFBR in QoS profiles as received from the SMF. The SMF may set the resource type of QoS flow 2 to non GBR

(iv) The SMF may include a QFI of the QoS flow 1 in the QoS profile of the Qos flow 2, or include a QFI of the QoS flow 2 in the QoS profile of the QoS flow 1.

### Implementation Example 1

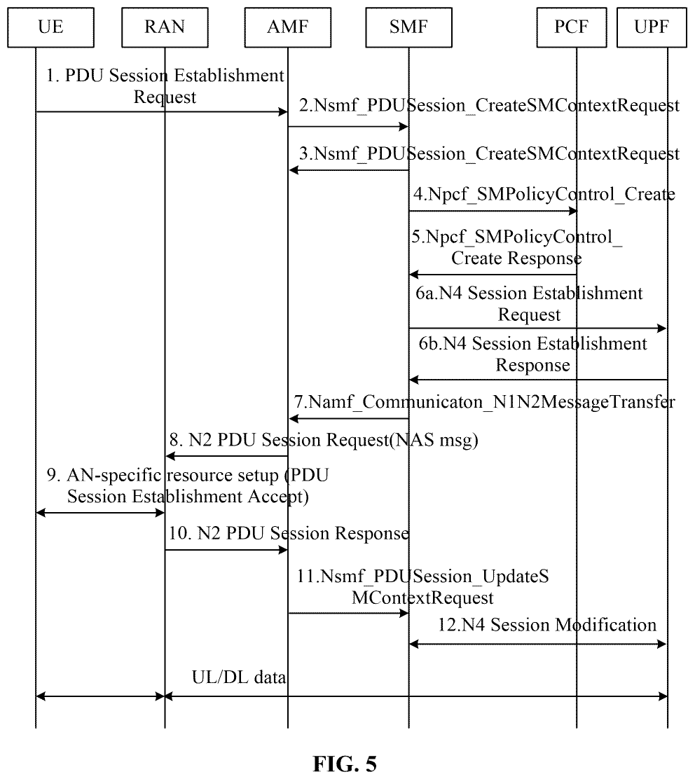

FIG. 5 illustrates a sequence diagram illustrating extended reality (XR) traffic. FIG. 5 shows how to activate an XR optimization in a UE, a RAN, and a UPF.

In step 1, a UE may send a non-access stratum (NAS) message to an AMF. The NAS message may include a data network name (DNN), a packet data unit (PDU) session ID, and N1 session management (SM) container (including a PDU session establishment request). In order to establish a new PDU session, the UE may generate a new PDU session ID. The UE may initiate the UE requested PDU session establishment procedure by the transmission of a NAS message containing a PDU session establishment request within the N1 SM container. The NAS message may include an UE capability indication that the UE supports XR optimization. The NAS message sent by the UE can be encapsulated by an access network (AN) in a N2 message towards the AMF.

In step 2, the AMF may select an SMF that supports the XR optimization based on the requested DNN, the UE capability indication, and other information. The AMF may send an Nsmf_PDUSession_CreateSMContext Request. The Nsmf_PDUSession_CreateSMContext Request may include a subscription permanent identifier (SUPI), a DNN, a PDU session ID, an AMF ID, a N1 SM container (including PDU session establishment request). The SUPI may uniquely identify the UE subscription. The AMF ID can be the UE's globally unique AMF ID (GUAMI) which uniquely identifies the AMF serving the UE. The AMF may forward the PDU session ID together with the N1 SM container containing the PDU session establishment request received from the UE. The AMF may also forward the UE capability indication to the SMF.

In step 3, if the SMF is able to process the PDU session establishment request, the SMF may create an SM context and may respond to the AMF by providing an SM context identifier in a Nsmf_PDUSession_CreateSMContext Response.

In step 4, the SMF may determine that a policy and charging control (PCC) authorization can be used. The SMF may request to establish an SM policy association with a PCF by invoking a Npcf_SMPolicyControl_Create operation.

In step 5, the PCF may perform an authorization based on a UE subscription and local configuration. The PCF may respond with a Npcf_SMPolicyControl_Create response. The PCF may provide policy information in the Npcf_SMPolicyControl_Create response. The PCF may determine that the PDU session can be used for XR traffic based on local configuration or information from an application function. In this case, the PCF may include XR information to activate the XR optimization in the UE, a RAN, and a UPF. The XR information may include an indication to activate the XR optimization and traffic filters of the XR traffic. The traffic filters may indicate how to detect the XR traffic (e.g., IP 5 tuple information of XR traffic), real-time transport protocol (RTP) header information, RTP pay-load information, real-time transport control protocol (RTCP) header information, secure real-time transport protocol (SRTP) header information, SRTP pay-load information, and secure real-time transport control protocol (SRTCP) information.

In step 6, the SMF may select an UPF supporting the XR optimization by using the DNN, the UE capability indication received from the AMF, and the XR information from the PCF. The SMF may send an N4 session establishment request to the UPF. The SMF may provide a packet detection, enforcement, and reporting rules to be installed on the UPF for this PDU session. The UPF may acknowledge by sending an N4 session establishment response. If core network (CN) tunnel information is allocated by the UPF, the CN tunnel information can be provided to the SMF in this step.

In step 7, the SMF may send a Namf_Communication_N1N2MessageTransfer to the AMF. The Namf_Communication_N1N2MessageTransfer may include a PDU session ID, N2 SM information, and a N1 SM container. The N2 SM information may include a PDU session ID, a QoS flow identifier (QFI), a QoS profile, and N3 CN tunnel information. The N1 SM container may include a PDU session establishment accept. The SMF may determine to establish two QoS flows (e.g., QoS flow 1 and QoS flow 2) for the XR traffic. The QoS flow 1 can transfer more important XR traffic, and the QoS flow 2 can transfer non-important XR traffic. The SMF may determine the QoS profiles of QoS flow 1 and QoS flow 2 as described above. The SMF may indicate the RAN in the QoS profiles that these two QoS flows are associated with each other. The AMF may forward N2 SM information to the RAN. The N1 SM container may contain the PDU session establishment accept that the AMF provides to the UE. The SMF may also indicate in the PDU session establishment accept that that these two QoS flows are associated with each other. The UE may classify more important uplink XR traffic and non-important uplink XR traffic by using the traffic filters. The UE may transfer the more important uplink XR traffic in the QoS flow 1, and may transfer the non-important uplink XR traffic in the QoS flow 2. For example, the UE may determine whether the XR traffic is important or non-important based on the “I” and “D” bits in the RTP header extension which are used to identify “Independent” and “Discardable” frames, or based on the “NRI” field of the network abstraction layer (NAL) unit header for H.264.

In step 8, the AMF may send a N2 PDU session request to the RAN. The N2 PDU session request may include N2 SM information and a NAS message. The NAS message may include a PDU session ID and a N1 SM container (including a PDU session establishment accept). The AMF may send the NAS message including a PDU session ID, a PDU session establishment accept targeted to the UE, and the N2 SM information received from the SMF within the N2 PDU session request to the 5G-AN.

In step 9, the RAN may issue an AN specific signaling exchange with the UE that is related with the information received from the SMF. For example, in case of a 3GPP RAN, a radio resource control (RRC) connection reconfiguration may take place with the UE establishing the RAN resources related to the QoS rules for the PDU session request. The RAN may forward the NAS message (including a PDU session ID, a N1 SM container (including a PDU session establishment accept)) to the UE. The RAN may also allocate AN N3 tunnel information for the PDU session.

In step 10, the RAN may send a N2 PDU session response to the AMF. The N2 PDU session response may include a PDU Session ID, a cause, and N2 SM information. The N2 SM information may include a PDU session ID, AN tunnel information, and a list of accepted/rejected QFI(s). If the RAN receives the information that QoS flow 1 and QoS flow 2 are associated with each other and the RAN supports the feature, the RAN may send information to the SMF. The information may indicate that the QoS flow 2 is successfully associated with QoS flow 1. The AN tunnel information may correspond to the access network address of the N3 tunnel corresponding to the PDU session.

In step 11, the AMF may send an Nsmf_PDUSession_UpdateSMContext Request (including N2 SM information) to the SMF. The AMF may forward the N2 SM information received from the RAN to the SMF. If the list of rejected QFI(s) is included in N2 SM information, the SMF may release the rejected QFI(s) associated QoS profiles.

In step 12, the SMF may initiate an N4 session modification procedure with the UPF. The SMF may provide AN tunnel information to PDU session anchor (PSA)/UPF0 as well as the corresponding forwarding rules. If the RAN sends information that the QoS flow 2 is successfully associated with the QoS flow 1, the SMF may provide information to the UPF to activate the downlink XR traffic classification based on important information of the PDU set of XR traffic. For example, the UPF may determine whether the XR traffic is important or non-important based on the “I” and “D” bits in the RTP header extension which are used to identify “Independent” and “Discardable” frames, or based on the “NRI” field of the NAL unit header for H.264.

### Implementation Example 2

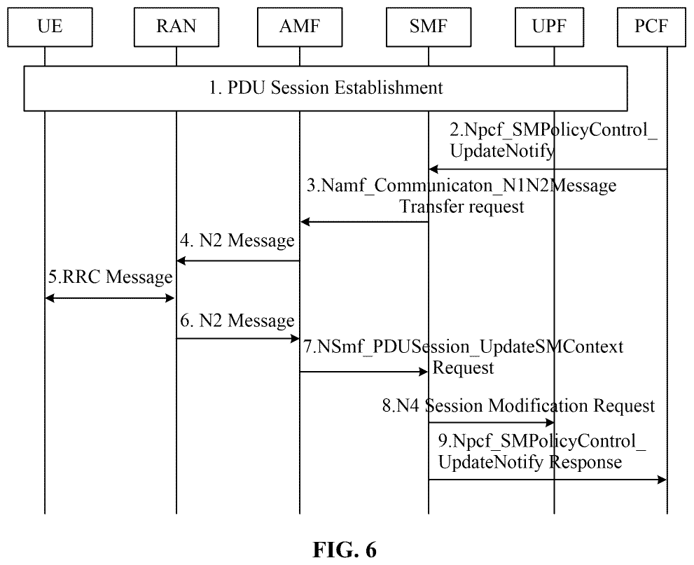

FIG. 6 shows how a policy control function (PCF) triggers an establishment of two QoS flows for XR traffic if they are not established during a PDU session establishment procedure.

In step 1, a UE may establish a PDU session with the network as described in the implementation example 1, without establishing QoS flows for XR traffic.

In step 2, a PCF may receive a request for QoS support for XR traffic from an XR application. The PCF may generate PCC rules for a service data flow of the XR Traffic, and may send the Npcf_SMPolicyControl_Update Notify to the SMF. The Npcf_SMPolicyControl_Update Notify may include PCC rules. The PCC rules may include information on how to identify the importance of the data packets within the XR traffic.

In step 3, the SMF may send a Namf_Communication_N1N2MessageTransfer to the AMF. The Namf_Communication_N1N2MessageTransfer may include a PDU session ID, N2 SM information, and a N1 SM container. The N2 SM information may include a PDU session ID, a QFI, a QoS profile, and N3 CN tunnel information. The N1 SM container may include a PDU session modification command. The SMF may determine to establish two QoS flows (e.g., QoS flow 1 and QoS flow 2) for the XR traffic. The QoS flow 1 can transfer the more important XR traffic, and the QoS flow 2 can transfer the non-important XR traffic. The SMF may determine the QoS profiles of QoS flow 1 and QoS flow 2 as described above. The SMF may indicate the RAN that these two QoS flows are associated with each other. The AMF may forward N2 SM information to the RAN. The N1 SM container may contain the PDU session modification command that the AMF provides to the UE. The PDU session modification command may also indicate that these two QoS flows are associated with each other. The UE may classify more important uplink XR traffic and non-important uplink XR traffic using traffic filters. The UE may transfer the more important uplink XR traffic in the QoS flow 1. The UE may transfer the non-important uplink XR traffic in the QoS flow 2. For example, the UE may determine whether the XR traffic is important or non important based on the “I” and “D” bits in the RTP header extension which are used to identify “Independent” and “Discardable” frames, or based on the “NRI” field of the network abstraction layer (NAL) unit header for H.264.

In step 4, the AMF may send a N2 PDU session request to the RAN. The N2 PDU session request may include N2 SM information and a NAS message. The NAS message may include a PDU session ID and a N1 SM container. The N1 SM container may include a PDU session modification command.

In step 5, the RAN may issue an AN specific signaling exchange with the UE that is related with the information received from the SMF. For example, in case of a 3GPP RAN, a RRC connection reconfiguration may take place with the UE establishing the RAN resources related to the QoS rules for the PDU session request. The RAN may forward the NAS message (including a PDU session ID, a N1 SM container (including a PDU session modification command)) to the UE. The RAN may also allocate AN N3 tunnel information for the PDU session.

In step 6, the RAN may send a N2 PDU session response to the AMF. The N2 PDU session response may include a PDU session ID, a cause, and N2 SM information. The N2 SM information may include a PDU Session ID, AN tunnel information, and a list of accepted/rejected QFI(s). If the RAN receives the information that QoS flow 1 and QoS flow 2 are associated with each other and RAN supports this feature, the RAN may send information to the SMF. The information may indicate that the QoS flow 2 is successfully associated with QoS flow 1. The AN tunnel information may correspond to the access network address of the N3 tunnel corresponding to the PDU session.

In step 7, the AMF may send an Nsmf_PDUSession_UpdateSMContext Request (including N2 SM information) to the SMF. The AMF may forward the N2 SM information received from the RAN to the SMF. If the list of rejected QFI(s) is included in N2 SM information, the SMF may release the rejected QFI(s) associated QoS profiles.

In step 8, the SMF may initiate an N4 session modification procedure with the UPF. The SMF may provide AN tunnel information to the PSA/UPF0 as well as the corresponding forwarding rules. If the RAN sends information that the QoS flow 2 is successfully associated with the QoS flow 1, the SMF may provide information to the UPF to activate the downlink XR traffic classification based on important information of the PDU set of XR traffic. For example, the UPF may determine whether the XR traffic is important or non-important based on the “I” and “D” bits in the RTP header extension which are used to identify “Independent” and “Discardable” frames, or based on the “NRI” field of the NAL unit header for H.264.

In step 9, the SMF may send a Npcf_SMPolicyControl_Update Notify response to the PCF to indicate that the QoS flow has been successfully established.

It should be understood that one or more features from the above implementation examples are not exclusive to the specific implementation examples, but can be combined in any manner (e.g., in any priority and/or order, concurrently or otherwise).

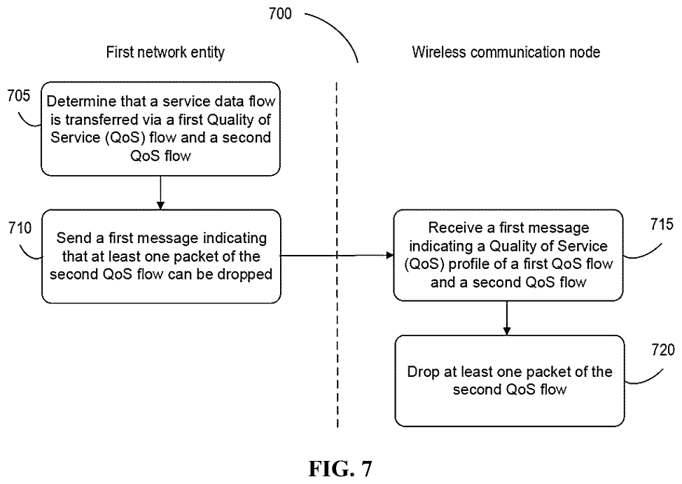

FIG. 7 illustrates a flow diagram for quality of service (QOS) handling for extended reality (XR) traffic, in accordance with an embodiment of the present disclosure. The method 700 may be implemented using any one or more of the components and devices detailed herein in conjunction with FIGS. 1-2. In overview, the method 700 may be performed by a first network entity, in some embodiments. Additional, fewer, or different operations may be performed in the method 700 depending on the embodiment. At least one aspect of the operations is directed to a system, method, apparatus, or a computer-readable medium.

A first network entity (e.g. a session management function (SMF)) can determine that a service data flow is transferred via a first Quality of Service (QOS) flow and a second QoS flow. The first network entity can send a first message indicating that at least one packet of the second QoS flow can be dropped when the wireless communication node determines that a sum of a first bit rate of the first QoS flow and a second bit rate of the second QoS flow is greater than a threshold associated with the first QoS flow to a wireless communication node (e.g., a radio access network (RAN)). The threshold can be a Maximum Flow Bit Rate (MFBR) of the first QoS flow.

In some embodiments, the first network entity may determine that a second priority value of the second QoS flow is less than a first priority value of the first QoS flow. The first network entity may send a second message indicating that the first QoS flow is a primary QoS flow and the second QoS flow is a secondary QoS flow to the wireless communication node.

In some embodiments, the first network entity may send a third message indicating that a second priority value of data packets included in the second QoS flow is less than a first priority value of data packets included in the first QoS flow to the wireless communication node.

In some embodiments, the first network entity may determine that a resource type of the second QoS flow is non-Guaranteed Bit Rate (non-GBR). The first network entity may include a QoS Flow identifier (QFI) of the first QoS flow in a QoS profile of the second QoS flow.

In some embodiments, the first network entity may send a fourth message that indicates the second network entity to forward a downlink service data flow into the first QoS flow and second QoS flow according to a traffic detection rule to a second network entity (e.g., a policy control function (PCF)).

In some embodiments, the first network entity may send a fifth message indicates that the first QoS flow and second QoS flow are associated with each other to a wireless communication device (e.g., a UE).

In some embodiments, a wireless communication node (e.g., a radio access network (RAN)) may receive a first message indicating a Quality of Service (QOS) profile of a first QoS flow and a second QoS flow from a first network entity (e.g., a session management function (SMF)). The wireless communication node may drop at least one packet of the second QoS flow when the wireless communication node determines that a sum of a first bit rate of the first QoS flow and a second bit rate of the second QoS flow is greater than a threshold associated with the first QoS flow. The first message includes information indicating that the at least one packet of the second QoS flow can be dropped when the wireless communication node determines that the sum of the first bit rate of the first QoS flow and a second bit rate of the second QoS flow is greater than the threshold associated with the first QoS flow.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
determining, by a first network entity, that a service data flow is transferred via a first Quality of Service (QOS) flow and a second QoS flow; and
sending, by the first network entity to a wireless communication node, a first message indicating that at least one packet of the second QoS flow can be dropped when the wireless communication node determines that a sum of a first bit rate of the first QoS flow and a second bit rate of the second QoS flow is greater than a threshold associated with the first QoS flow.

2. The wireless communication method of claim 1, wherein the threshold is a Maximum Flow Bit Rate (MFBR) of the first QoS flow.

3. The wireless communication method of claim 1, further comprising:
determining, by the first network entity, that a second priority value of the second QoS flow is less than a first priority value of the first QoS flow.

4. The wireless communication method of claim 1, further comprising:
sending, by the first network entity to the wireless communication node, a second message indicating that the first QoS flow is a primary QoS flow and the second QoS flow is a secondary QoS flow.

5. The wireless communication method of claim 1, further comprising:
sending, by the first network entity to the wireless communication node, a third message indicating that a second priority value of data packets included in the second QoS flow is less than a first priority value of data packets included in the first QoS flow.

6. The wireless communication method of claim 1, further comprising:
determining, by the first network entity, that a resource type of the second QoS flow is non-Guaranteed Bit Rate (non-GBR).

7. The wireless communication method of claim 1, further comprising:
including, by the first network entity, a QoS Flow identifier (QFI) of the first QoS flow in a QoS profile of the second QoS flow.

8. The wireless communication method of claim 1, further comprising:
sending, by the first network entity to a second network entity, a fourth message that indicates the second network entity to forward a downlink service data flow into the first QoS flow and second QoS flow according to a traffic detection rule.

9. The wireless communication method of claim 1, further comprising:
sending, by the first network entity to a wireless communication device, a fifth message indicates that the first QoS flow and second QoS flow are associated with each other.

10. A wireless communication method, comprising:
receiving, by a wireless communication node from a first network entity, a first message indicating a Quality of Service (QOS) profile of a first QoS flow and a second QoS flow; and
dropping, by the wireless communication node, at least one packet of the second QoS flow when the wireless communication node determines that a sum of a first bit rate of the first Qos flow and a second bit rate of the second QoS flow is greater than a threshold associated with the first QoS flow.

11. The wireless communication method of claim 10, wherein the first message includes information indicating that the at least one packet of the second QoS flow can be dropped when the wireless communication node determines that the sum of the first bit rate of the first QoS flow and a second bit rate of the second QoS flow is greater than the threshold associated with the first QoS flow.

12. A non-transitory computer readable medium storing instructions, which when executed by at least one processor, cause the at least one processor to perform the method of claim 1.

13. An apparatus comprising:
at least one processor configured to implement the following:
determining that a service data flow is transferred via a first Quality of Service (QOS) flow and a second QoS flow; and
sending, to a wireless communication node, a first message indicating that at least one packet of the second QoS flow can be dropped when the wireless communication node determines that a sum of a first bit rate of the first QoS flow and a second bit rate of the second QoS flow is greater than a threshold associated with the first QoS flow.

14. The apparatus of claim 13, wherein the threshold is a Maximum Flow Bit Rate (MFBR) of the first QoS flow.

15. The apparatus of claim 13, wherein the at least one processor is configured to further implement:
determining, by the first network entity, that a second priority value of the second QoS flow is less than a first priority value of the first QoS flow.

16. The apparatus of claim 13, wherein the at least one processor is configured to further implement:
sending, by the first network entity to the wireless communication node, a second message indicating that the first QOS flow is a primary QoS flow and the second QoS flow is a secondary QoS flow.

17. The apparatus of claim 13, wherein the at least one processor is configured to further implement:
sending, by the first network entity to the wireless communication node, a third message indicating that a second priority value of data packets included in the second QoS flow is less than a first priority value of data packets included in the first QoS flow.

18. The apparatus of claim 13, wherein the at least one processor is configured to further implement:
determining, by the first network entity, that a resource type of the second QoS flow is non-Guaranteed Bit Rate (non-GBR).

19. A non-transitory computer readable medium storing instructions, which when executed by at least one processor, cause the at least one processor to perform the method of claim 10.

20. An apparatus comprising at least one processor configured to implement the method of claim 10.
